(19) United States
(12) Patent Application Publication
(10) Pub. No.: US 2022/0327210 A1
(43) Pub. Date: Oct. 13, 2022

(54) LEARNING APPARATUS, DETERMINATION SYSTEM, LEARNING METHOD, AND NON-TRANSITORY COMPUTER READABLE MEDIUM STORING LEARNING PROGRAM

(71) Applicant: NEC Corporation, Minato-ku, Tokyo (JP)

(72) Inventor: Yohei OGAWA, Tokyo (JP)

(73) Assignee: NEC Corporation, Minato-ku, Tokyo (JP)

(21) Appl. No.: 17/642,722

(22) PCT Filed: Sep. 27, 2019
(86) PCT No.: PCT/JP2019/038283

§ 371 Date: Mar. 14, 2022

(51) Int. Cl. G06F 21/56; G06K 9/62

(52) U.S. Cl. CPC G06F 21/561; G06F 21/566; G06K 9/6215; G06K 9/6218

(57) ABSTRACT

A learning apparatus according to the present disclosure includes a first classification unit for classifying a plurality of first malware programs collected in a first period of time into a plurality of clusters, a second classification unit for classifying a plurality of second malware programs collected in a second period of time into the plurality of clusters, and a learning unit for creating a learning model for determining whether a file is malware based on feature amounts of the plurality of clusters according to a result of the classification of the plurality of second malware programs.

### TECHNICAL FIELD

The present disclosure relates to a learning apparatus, a determination system, a learning method, and a non-transitory computer readable medium storing a learning program.

### BACKGROUND ART

In recent years, machine learning, as represented by deep learning, has been actively studied and applied to various fields. For example, machine learning is being used to detect malware that continues to grow on the Internet every year.

As related art, for example, Patent Literature 1 is known. Patent Literature 1 discloses a technique for performing clustering and creating a detection model in order to detect malware.

### CITATION LIST

### Patent Literature

Patent Literature 1: Japanese Unexamined Patent Application Publication No. 2018-133004

### SUMMARY OF INVENTION

### Technical Problem

As disclosed in Patent Literature 1, a related technique uses machine learning to detect malware and performs clustering based on a feature amount to create a learning model. However, in the related technique, there is a problem that it is sometimes difficult to create a learning model capable of accurately determining whether a file is malware.

In view of such a problem, an object of the present disclosure is to provide a learning apparatus, a determination system, a learning method, and a non-transitory computer readable medium storing a learning program capable of creating a learning model that can improve an accuracy of determining whether a file is malware.

### Solution to Problem

A learning apparatus according to the present disclosure includes: first classification means for classifying a plurality of first malware programs collected in a first period of time into a plurality of clusters; second classification means for classifying a plurality of second malware programs collected in a second period of time into the plurality of clusters; and learning means for creating a learning model for determining whether a file is malware based on feature amounts of the plurality of clusters according to a result of the classification of the plurality of second malware programs.

A determination system according to the present disclosure includes: first classification means for classifying a plurality of first malware programs collected in a first period of time into a plurality of clusters; second classification means for classifying a plurality of second malware programs collected in a second period of time into the plurality of clusters; learning means for creating a learning model for determining whether an input file is malware based on feature amounts of the plurality of clusters according to a result of the classification of the plurality of second malware programs; and determination means for determining whether or not the input file is the malware based on the created learning model.

A learning method according to the present disclosure includes: classifying a plurality of first malware programs collected in a first period of time into a plurality of clusters; classifying a plurality of second malware programs collected in a second period of time into the plurality of clusters; and creating a learning model for determining whether a file is malware based on feature amounts of the plurality of clusters according to a result of the classification of the plurality of second malware programs.

A non-transitory computer readable medium storing a learning program according to the present disclosure causes a computer to execute: classifying a plurality of first malware programs collected in a first period of time into a plurality of clusters; classifying a plurality of second malware programs collected in a second period of time into the plurality of clusters; and creating a learning model for determining whether a file is malware based on feature amounts of the plurality of clusters according to a result of the classification of the plurality of second malware programs.

### Advantageous Effects of Invention

According to the present disclosure, it is possible to provide a learning apparatus, a determination system, a learning method, and a non-transitory computer readable medium storing a learning program capable of creating a learning model that can improve an accuracy of determining whether a file is malware.

### BRIEF DESCRIPTION OF DRAWINGS

FIG. 1 is a flowchart showing a related learning method;

FIG. 2 is a schematic diagram showing an outline of a learning apparatus according to an example embodiment;

FIG. 3 is a schematic diagram showing an outline of a determination system according to an example embodiment;

FIG. 4 is a block diagram showing a configuration example of a determination system according to a first example embodiment;

FIG. 5 is a block diagram showing another configuration example of the determination system according to the first example embodiment;

FIG. 6 is a flowchart showing a learning method according to the first example embodiment;

FIG. 7 is a flowchart showing existing malware processing in the learning method according to the first example embodiment;

FIG. 8 is a flowchart showing new malware processing in the learning method according to the first example embodiment;

FIG. 9 shows an example of feature amounts in the learning method according to the first example embodiment;

FIG. 10 shows an image of clustering of existing malware in the learning method according to the first example embodiment;

FIG. 11 shows an image of leveling in the learning method according to the first example embodiment;

FIG. 12 shows an image of leveling in the learning method according to the first example embodiment;

FIG. 13 shows an image of clustering of new malware in the learning method according to the first example embodiment;

FIG. 14 shows an adjustment image of a feature amount of a cluster in the learning method according to the first example embodiment; and

FIG. 15 is a flowchart showing a determination method according to the first example embodiment.

### DESCRIPTION OF EMBODIMENTS

An example embodiment will be described below with reference to the drawings. The following descriptions and drawings have been omitted and simplified as appropriate for clarification of the description. In each of the drawings, the same elements are denoted by the same reference signs, and repeated descriptions are omitted as necessary.

### Investigation Leading to Example Embodiment

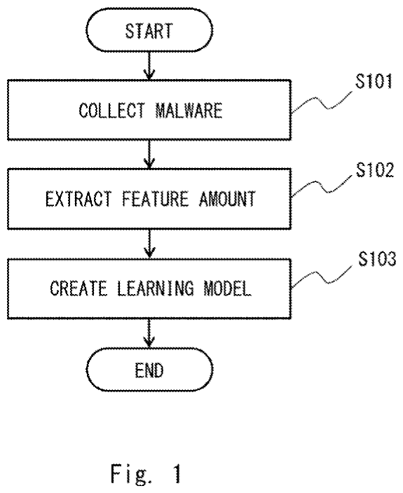

As a related technique, a method for determining whether a file is malware using a learning model using deep learning will be investigated. FIG. 1 shows a related learning method. As shown in FIG. 1, in the related learning method, a large amount of malware as a sample is collected (S101), a feature amount of the collected malware is extracted (S102), and a learning model is created using the extracted feature amount of the malware (S103).

Thus, in the related learning method, by learning feature amounts of a large amount of malware, “features” common to the malware can be found, and it is possible to determine whether a file is malware with respect to various kinds of malware. Note that malware is software or data that performs unauthorized (malicious) operations on a computer or a network, such as computer viruses or worms.

However, the inventor has found a problem that with the related learning method, it takes time to extract feature amounts. That is, in the related learning method, since it is necessary to extract the feature amounts of many malware programs collected as samples, it requires an enormous time to perform processing of extracting the feature amounts.

The inventor has also found a problem that it is not possible to accurately determine whether a file is malware if a learning model obtained by such a related learning method is used. In other words, since there is a “variation” in the malware to be learned, an accuracy of determining whether a file is malware (hereinafter referred to as a determination accuracy) may be lowered or the determination accuracy may become unstable depending on the sample. For example, only samples collected by some methods may improve the determination accuracy, while samples collected by other methods may deteriorate the determination accuracy. Further, while a trend in malware features may change depending on when the malware features are collected, such a trend in malware is not considered in the related learning method. Therefore, it is difficult for the related learning method to accurately determine the latest trend in malware. In addition, in order to support the latest malware, it is necessary to continuously learn malware (to continuously extract the feature amount), which may increase the system maintenance cost.

In this manner, when the related learning method is used, it takes time to extract the feature amounts, and it is not possible to accurately determine whether a file is malware. In order to address this issue, the following example embodiment provides a solution for solving at least one of the problems. In particular, in the following example embodiment, it is possible to improve the determination accuracy of malware in consideration of the latest trend in malware.

### Outline of Example Embodiment

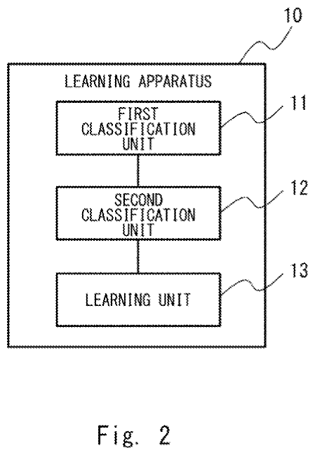

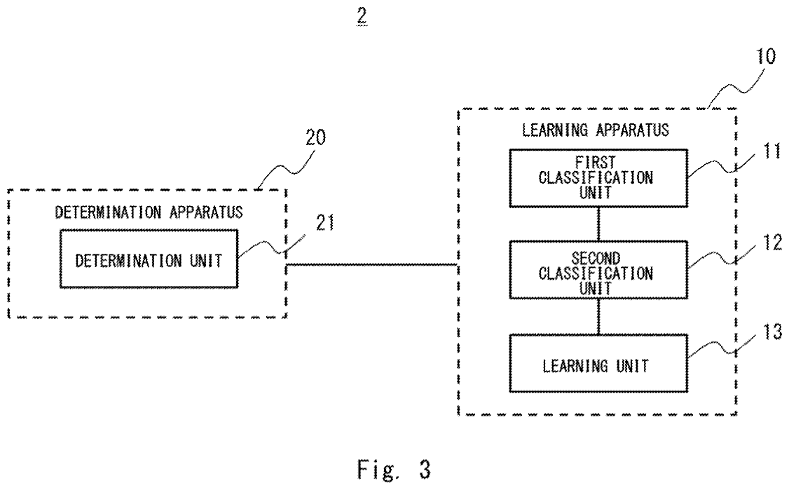

FIG. 2 shows an outline of a learning apparatus according to example embodiment, and FIG. 3 shows an outline of a determination system according to the example embodiment. As shown in FIG. 2, the learning apparatus 10 includes a first classification unit 11, a second classification unit 12, and a learning unit 13.

The first classification unit 11 classifies a plurality of first malware programs collected in a first period of time (for example, a period of time after the most recent period of time) into a plurality of clusters. The second classification unit 12 classifies a plurality of second malware programs collected in a second period of time (for example, the most recent period of time) into a plurality of clusters classified by the first classification unit 11. The learning unit 13 creates a learning model for determining whether a file is malware based on the feature amount of the plurality of clusters corresponding to the result of the classification of the plurality of second malware programs classified by the second classification unit 12.

As shown in FIG. 3, the determination system 2 includes the learning apparatus 10 and a determination apparatus 20. The determination apparatus 20 includes a determination unit 21 for determining whether or not an input file is malware based on the determination learning model created by the learning apparatus 10. In the determination system 2, the configurations of the learning apparatus 10 and the determination apparatus 20 are not limited thereto. That is, the determination system 2 is not limited to the configuration including the learning apparatus 10 and the determination apparatus 20, and includes at least the first classification unit 11, the second classification unit 12, the learning unit 13, and the determination unit 21.

Thus, in the example embodiment, the plurality of first malware programs (for example, existing malware programs) collected in the first period of time are classified into a plurality of clusters, and then the plurality of second malware programs (for example, new malware programs) collected in the second period of time are classified into the plurality of clusters, and a learning model is created according to the classification results. By doing so, learning can be performed corresponding not only to the malware programs in the first period of time but also to the malware programs in the second period of time, and thus it is possible to create a learning model capable of improving the determination accuracy of malware.

### First Example Embodiment

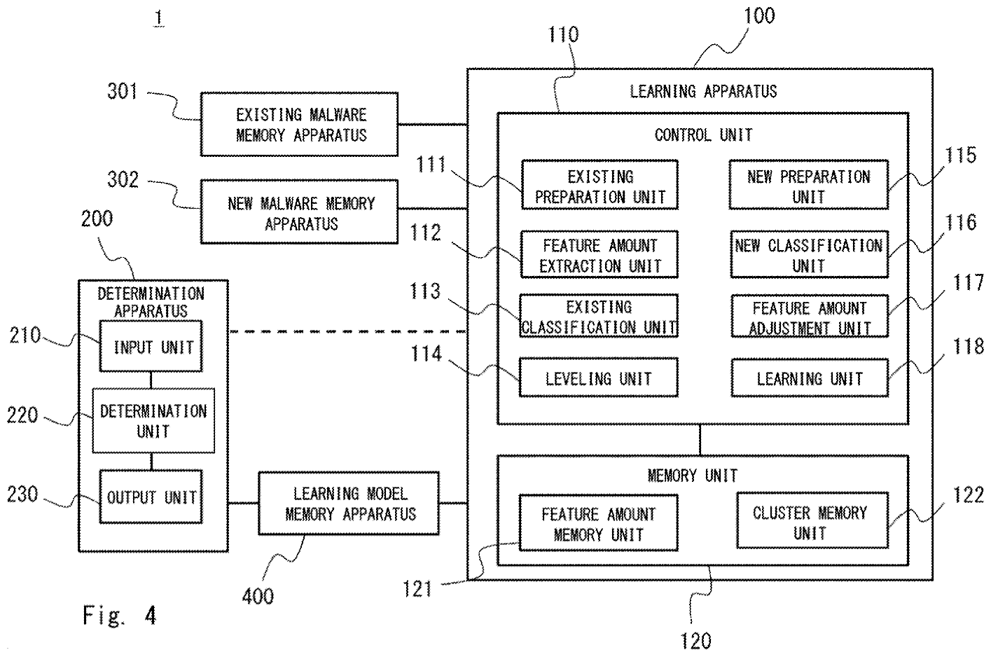

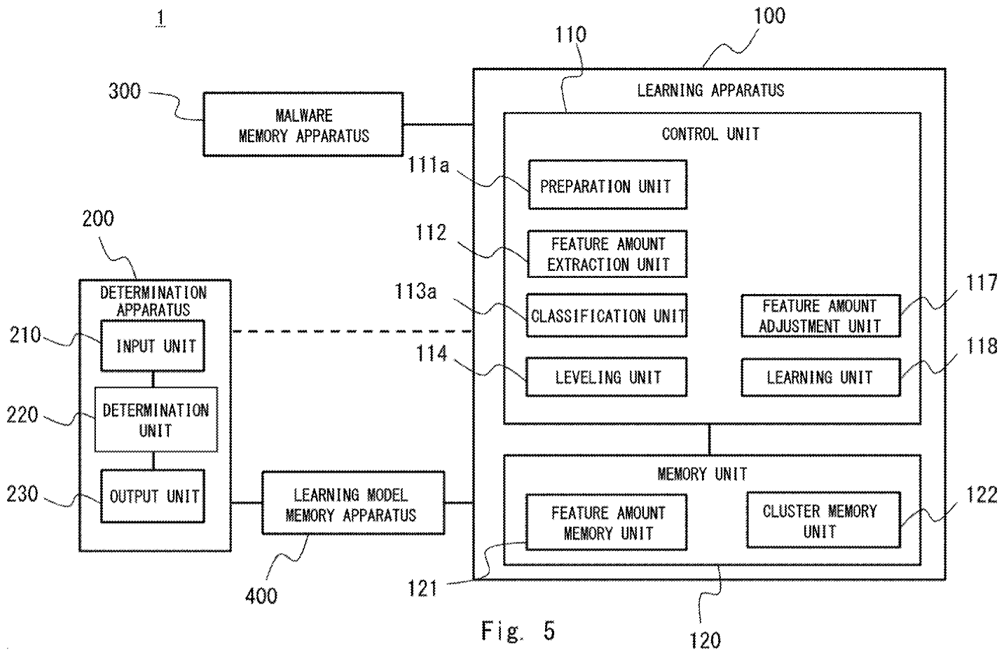

A first example embodiment will be described below with reference to the drawings. FIG. 4 shows a configuration example of the determination system 1 according to this example embodiment. FIG. 5 shows another configuration example of the determination system 1 according to this example embodiment. The determination system 1 is a system for determining whether or not a file provided by a user is malware using a learning model trained with features of malware.

As shown in FIG. 4, for example, the determination system 1 includes a learning apparatus 100, a determination apparatus 200, an existing malware memory apparatus 301, a new malware memory apparatus 302, and a learning model memory apparatus 400. For example, each apparatus of the determination system 1 is constructed on a cloud, and services of the determination system 1 are provided by SaaS (Software as a Service). That is, each apparatus is implemented by a computer apparatus such as a server or a personal computer, or may be implemented by one physical apparatus, or may be implemented by a plurality of apparatuses on a cloud by a virtualization technology or the like. The configuration of each apparatus and each unit (block) in the apparatus is an example, and may be composed of other apparatuses and units, respectively, if a method (operation) described later can be performed. For example, the determination apparatus 200 and the learning apparatus 100 may be integrated into one apparatus, or each apparatus may be composed of a plurality of apparatuses. The existing malware memory apparatus 301, the new malware memory apparatus 302, and the determination learning model memory apparatus 400 may be included in the determination apparatus 200 and the learning apparatus 100. Further, memory units included in the determination apparatus 200 and the learning apparatus 100 may be external memory apparatuses.

The existing malware memory apparatus 301 and the new malware memory apparatus 302 are database apparatuses for storing a large amount of malware as samples for learning. The existing malware memory apparatus 301 and the new malware memory apparatus 302 may store previously collected malware or may store information provided on the Internet during respective collection periods. The existing malware memory apparatus 301 stores malware (called existing malware) collected in the first period of time which is a period after the most recent period of time. The new malware memory apparatus 302 stores malware (called new malware) collected in the second period of time which is the most recent period after the first period of time. For example, if a trend in malware changes in a three-month cycle (quarterly), the second period of time is the most recent three months, and the first period of time is the three months preceding the second period of time (and may include a period of time preceding the three months preceding the second period of time). For example, malware collected in the most recent three months is defined as new malware, and malware collected before the most recent three months is defined as existing malware. The period of three months is an example, and may be any period (may be any year, month, or day).

The determination learning model memory apparatus 400 stores learning models for determining whether a file is malware. The determination learning model memory apparatus 400 stores the learning models created by the learning apparatus 100, and the determination apparatus 200 refers to the stored learning models for determining whether a file is malware.

The learning apparatus 100 is an apparatus for creating the learning model trained with the feature of malware as a sample. The learning apparatus 100 classifies the existing malware into clusters, classifies new malware into the clusters, and then creates a learning model. The learning apparatus 100 includes a control unit 110 and a memory unit 120. The learning apparatus 100 may also include an input unit, an output unit, etc. as a communication unit to communicate with the determination apparatus 200, the Internet, or the like, or as an interface with a user, an operator, or the like, if necessary.

The memory unit 120 stores information necessary for the operation of the learning apparatus 100. The memory unit 120 is a non-volatile memory unit (storage unit), and is, for example, a non-volatile memory such as a flash memory or a hard disk. The memory unit 120 includes a feature amount memory unit 121 for storing feature amounts of malware, and a cluster memory unit 122 for storing information about the clusters into which the malware is classified. The memory unit 120 further stores a program or the like necessary for creating the learning model by machine learning.

The control unit 110 is for controlling the operations of each unit of the learning apparatus 100, and is a program execution unit such as a CPU (Central Processing Unit). The control unit 110 reads the program stored in the memory unit 120 and executes the read program to implement each function (processing). As this function, the control unit 110 includes, for example, an existing preparation unit 111, a feature amount extraction unit 112, an existing classification unit 113, a leveling unit 114, a new preparation unit 115, a new classification unit 116, a feature amount adjustment unit 117, and a learning unit 118.

The existing preparation unit 111, the feature amount extraction unit 112, the existing classification unit 113, and the leveling unit 114 are existing malware processing units (first processing units) that perform existing malware processing, which will be described later.

The existing preparation unit 111 performs preparation necessary for learning existing malware. The existing preparation unit 111 refers to the existing malware memory apparatus 301 to prepare samples of existing malware and selects the samples of the existing malware for learning. The existing preparation unit 111 may prepare and select the sample based on a predetermined standard, or may prepare and select the samples according to an input operation of the user or the like.

The feature amount extraction unit 112 extracts a feature amount indicating a feature of the existing malware. The feature amount extraction unit 112 extracts the feature amount of the selected existing malware according to a predetermined feature amount extraction rule, and stores the extracted feature amount in the feature amount memory unit 121. The feature amount extraction rule may be stored in advance in the memory unit 120, or may be designated according to an operation by the user or the like.

The existing classification unit (the first classification unit) 113 classifies the existing malware into clusters. The existing classification unit 113 classifies the selected existing malware into clusters and stores cluster information about the classified clusters in the cluster memory unit 122. The existing classification unit 113 performs clustering based on a similarity of existing malware programs by a predetermined clustering method such as hierarchical clustering. The cluster information includes information indicating malware programs included in each cluster, a feature amount of the malware programs in each cluster, etc.

The leveling unit 114 levels each cluster in which the existing malware programs are classified. The leveling unit 114 refers to the cluster information stored in the cluster memory unit 122, levels the cluster information based on the number of malware programs (or feature amount) of each cluster, and updates the cluster information in the cluster memory unit 122. For example, the leveling unit 114 levels the number of malware programs (or feature amount) in all clusters by a predetermined sampling algorithm such as oversampling or undersampling.

The new preparation unit 115, the new classification unit 116, and the feature amount adjustment unit 117 are new malware processing units (second processing units) for performing new malware processing, which will be described later.

The new preparation unit 115 performs preparation necessary for learning new malware. The new preparation unit 115 refers to the new malware memory apparatus 302, prepares a sample of the new malware, and selects a sample of the new malware for learning. In a manner similar to the existing preparation unit 111, the new preparation unit 115 may prepare and select the sample based on a predetermined standard, or may prepare and select the samples according to an input operation of the user or the like.

The new classification unit (the second classification unit) 116 classifies the new malware programs into the clusters. The new classification unit 116 refers to the cluster information stored in the cluster memory unit 122, classifies the existing malware programs, classifies the selected new malware programs into the leveled cluster, and updates the cluster information in the cluster memory unit 122. The new classification unit 116 classifies the new malware programs so that the new malware programs belong to one of the clusters based on the similarity between the new malware and the cluster.

The feature amount adjustment unit 117 adjusts the feature amount of each cluster in which the new malware programs are classified. The feature amount adjustment unit 117 refers to the cluster information stored in the cluster memory unit 122, adjusts the feature amount of each cluster according to the classification result of the new malware programs for each cluster, and updates the cluster information of the cluster memory unit 122. For example, the feature amount of each cluster is adjusted according to the number of classified new malware programs or a classification rate of the new malware programs for each cluster.

The learning unit 118 learns using the adjusted feature amount of each cluster. The learning unit 118 refers to cluster information stored in the cluster memory unit 122, creates a learning model based on the feature amount of each cluster adjusted according to the classification result, and stores the created learning model in the learning model memory apparatus 400. The learning unit 118 creates a learning model by making a machine learner such as SVM (Support Vector Machine) learn the feature amount of malware programs of each cluster as supervised data.

The determination apparatus 200 determines whether or not a file provided by the user is malware. The determination apparatus 200 includes an input unit 210, a determination unit 220, and an output unit 230. The determination apparatus 200 may also include a communication unit to communicate with the learning apparatus 100, the Internet, or the like, if necessary.

The input unit 210 acquires a file input from the user. The input unit 210 receives the uploaded file via a network such as the Internet.

The determination unit 220 determines whether or not the file is malware based on the learning model created by the learning apparatus 100. The determination unit 220 refers to the learning model stored in the learning model memory apparatus 400 and determines whether or not the feature of the file is close to the feature of the malware.

The output unit 230 outputs a result of determining whether the input file is malware obtained by the determination unit 220 to the user. The output unit 230 outputs the result of determining whether the file is malware via a network such as the Internet, in a manner similar to the input unit 210.

Note that the learning apparatus 100 is not limited to the configuration shown in FIG. 4, but may be configured as shown in FIG. 5. That is, since the existing malware processing and the new malware processing may be performed at different timings, the existing malware processing and the new malware processing may be performed in the same block. For example, the existing preparation unit 111 and the new preparation unit 115 may be one preparation unit 111a, and the existing classification unit 113 and the new classification unit 116 may be one classification unit 113a. The existing malware memory apparatus 301 and the new malware memory apparatus 302 may be one malware memory apparatus 300.

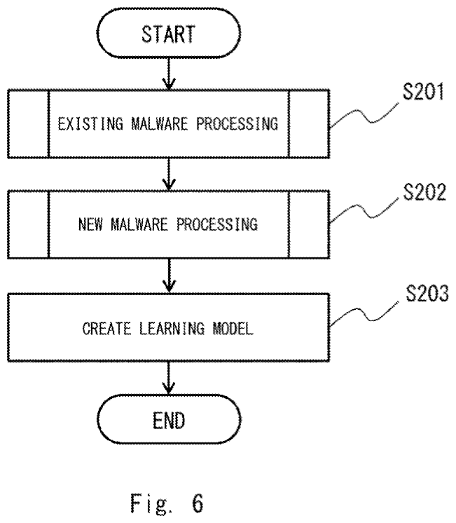

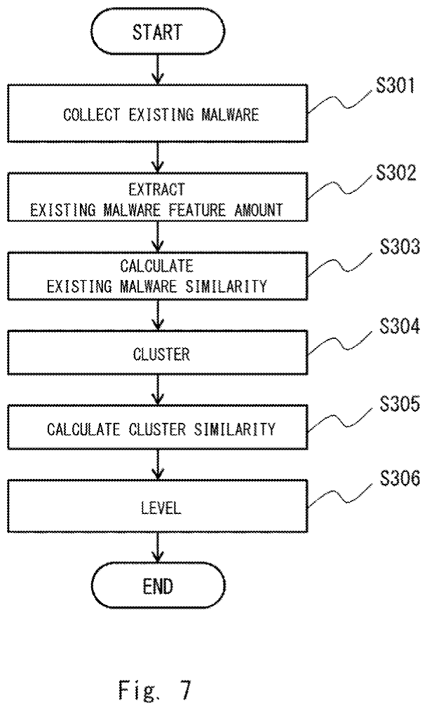

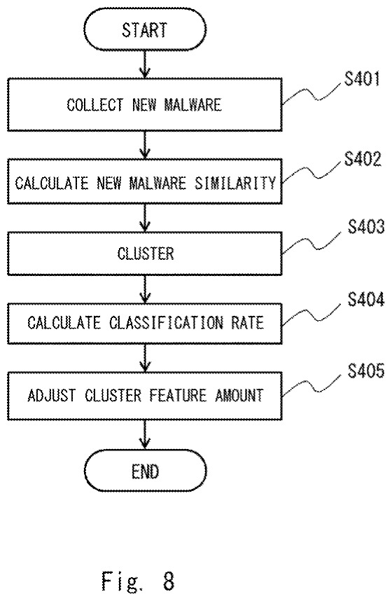

FIG. 6 shows a learning method implemented by the learning apparatus 100 according to this example embodiment. FIG. 7 shows the existing malware processing in the learning method of FIG. 6. FIG. 8 shows the new malware processing in the learning method of FIG. 6.

As shown in FIG. 6, in the learning method according to this example embodiment, first, the learning apparatus 100 performs the existing malware processing as a first step (S201), performs the new malware processing as a second step (S202), and then creates a learning model (S203). For example, the existing malware processing is performed in the first period of time (for example, three months before the second period of time) (S201), and the new malware processing is performed and a learning model is created in the second period of time (for example, three months after the first period of time) (S202 and S203). If each of the existing malware memory apparatus 301 and the new malware memory apparatus 302 stores necessary malware programs, S201 to S203 may be performed in the same period of time.

In the existing malware processing in S201, as shown in FIG. 7, the learning apparatus 100 first collects existing malware programs which are existing samples (S301). That is, the existing preparation unit 111 prepares a large number of malware samples in the first period of time from the existing malware memory apparatus 301, the Internet, or the like. The existing preparation unit 111 selects existing malware programs for learning from the prepared existing malware programs based on a predetermined standard or the like.

Next, the learning apparatus 100 extracts the feature amounts of the existing malware programs (S302). That is, the feature amount extraction unit 112 extracts the feature amounts of the existing malware programs to be learned as samples.

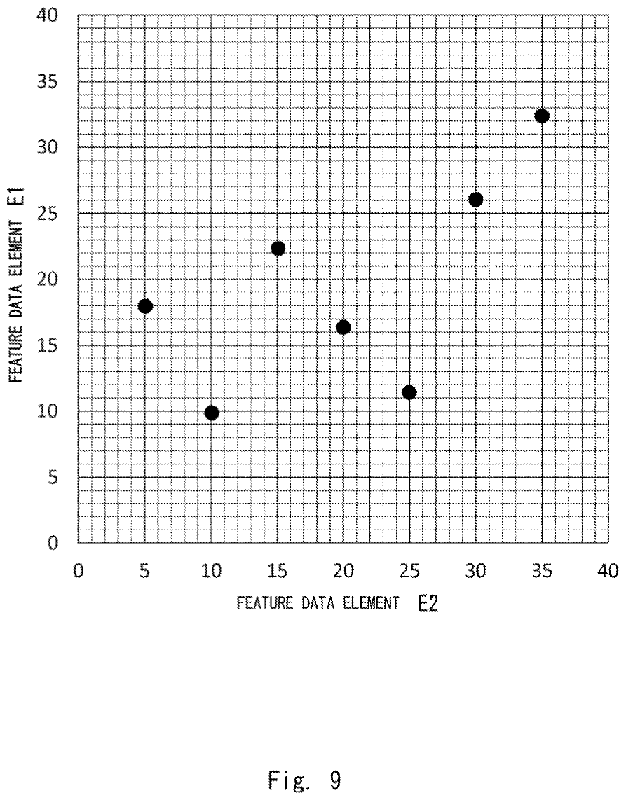

FIG. 9 shows an image of the feature amounts in S302. The feature amounts are data indicating the features of the malware programs, and are numerical data of a plurality of feature data elements. The feature data element is based on a predetermined feature amount extraction rule, and is, for example, the number of occurrences of a predetermined string pattern. The predetermined string may be 1 to 3 characters or a string of any length. The feature data element includes the number of accesses to a predetermined file, the number of calls of a predetermined API (Application Programming Interface), or the like.

FIG. 9 shows an example of two-dimensional feature data elements of feature data elements E1 and E2. For example, the feature data elements E1 and E2 are the number of occurrences of different string patterns. More feature data elements are preferably used to improve the accuracy of determining whether a file is malware. For example, 100 to 200 patterns for each of 1 character, 2 characters, and 3 characters may be prepared, and the number of occurrences of all patterns may be used as the feature data elements.

Next, the learning apparatus 100 classifies the existing malware programs into clusters (S303 to S305). Specifically, the learning apparatus 100 calculates the similarities of the existing malware programs (S303), clusters the existing malware programs (S304), and calculates the similarity of the clusters (S305). That is, the existing classification unit 113 calculates the similarity between malware samples and classifies the malware programs with the highest similarity into the same cluster. The existing classification unit 113 further calculates the similarity between the classified clusters to perform clustering, and repeats the calculation of the similarity and clustering as necessary. The similarity calculated here is the similarity of classification elements for clustering. The classification element may be a part of a plurality of feature data elements in the feature amount, or may be an element different from the feature data element. The classification elements are not all feature data elements in the feature amount, and instead are elements that can be calculated more easily than the feature amount. For example, the classification element is the number of occurrences of a predetermined string pattern (a part of the string pattern used in the feature amount).

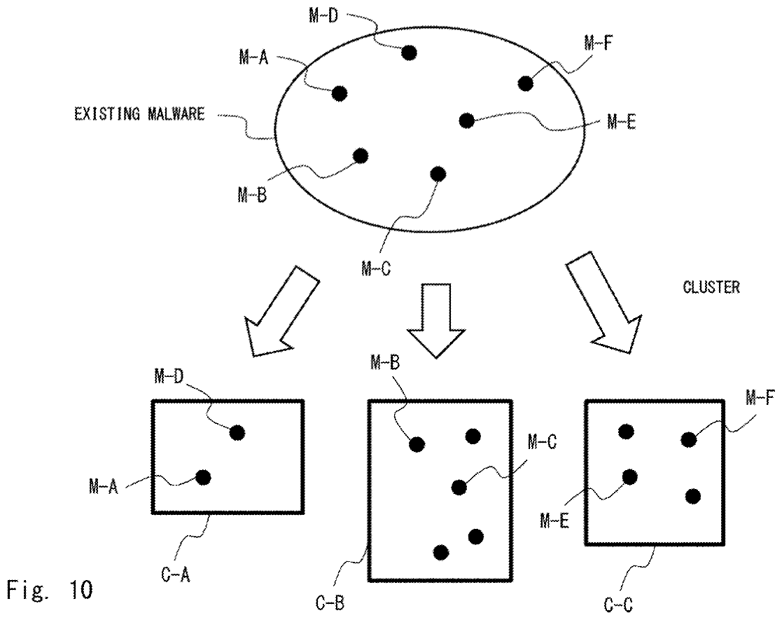

FIG. 10 shows an image of the clustering in S304. In the example of FIG. 10, the existing malware includes malware programs M-A to M-F. Since the similarity between the malware program M-A and the malware program M-D is the highest (for example, the numbers of occurrences of a predetermined string pattern are the closest), the malware programs are classified into a cluster C-A. Further, since the similarity between the malware program M-B and the malware program M-C is the highest, the malware programs are classified into a cluster C-B. Furthermore, since the similarity between the malware program M-E and the malware program M-F is the highest, the malware program are classified into a cluster C-C.

Next, the learning apparatus 100 levels the clusters (S306). That is, the leveling unit 114 averages the cluster size of each cluster. The cluster size is the number of malware programs in the cluster and the feature amounts of the malware programs in the cluster. The leveling unit 114 increases the feature amount of the cluster having a small number of malware programs by a sampling algorithm or the like so that a part of the feature amount of the cluster having a large number of malware programs is not used for learning.

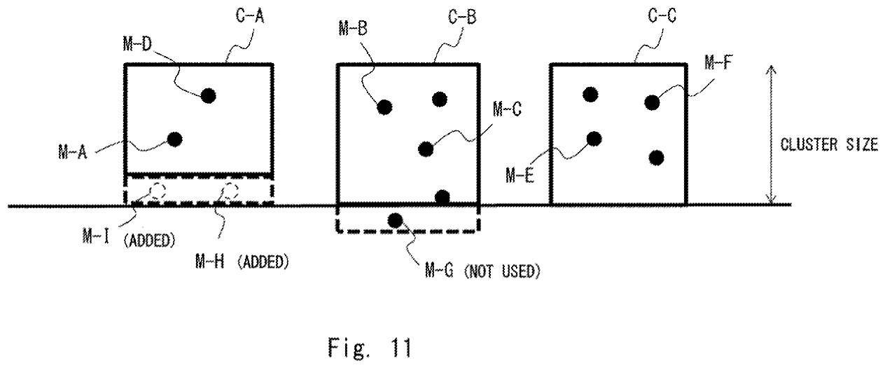

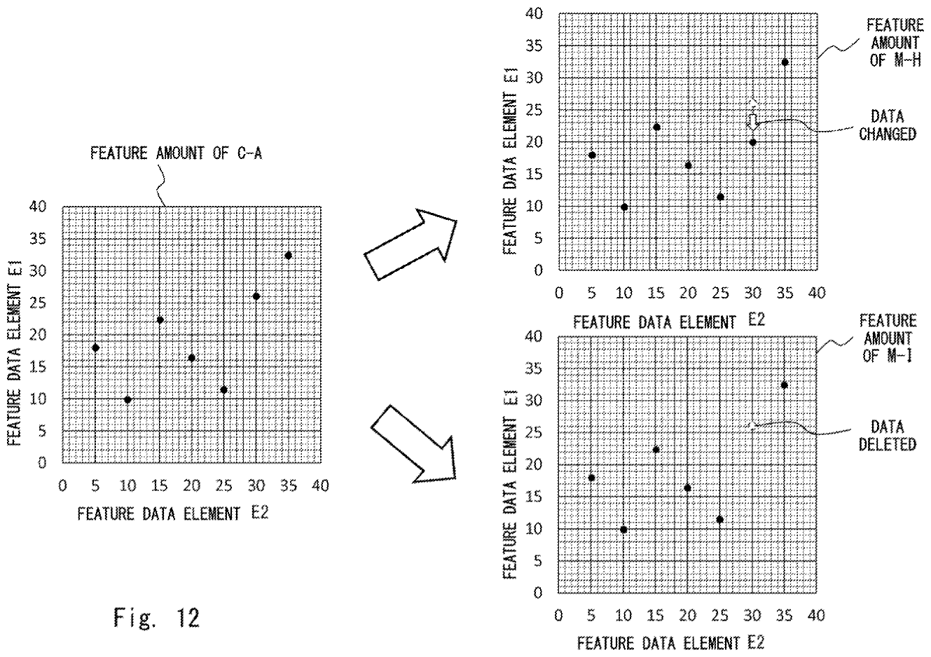

FIGS. 11 and 12 show images of the leveling. For example, as shown in FIG. 11, when the number of clusters C-A is 2, the number of clusters C-B is 5, and the number of clusters C-C is 4, the number of clusters of each cluster is adjusted to be 4 which is an average value. For the cluster C-B, since the number of clusters is 5, for example, the feature amount of a malware program M-G is not used (the malware program is deleted from the cluster). For the cluster C-A, since the number of clusters is 2, a feature amount close to the feature amounts of the malware programs M-A and M-D is added. In this example, feature amounts of dummy malware programs M-H and M-I are generated and added to the cluster C-A. For example, by changing the data of the feature amount (e.g., the average value of the feature amounts of the malware programs M-A and M-D) of the cluster C-A or deleting or increasing the data, the feature amounts of the malware programs M-H and M-I close to the feature amount of the cluster C-A is generated. For example, as shown in FIG. 12, only one data value included in the feature amount of the cluster C-A is changed to generate the feature amount of the malware program M-H. Further, only one data included in the feature amount of the cluster C-A is deleted to generate the feature amount of the malware program M-I.

Following the existing malware processing in S201, in the new malware processing in S202, as shown in FIG. 8, the learning apparatus 100 first collects new malware programs which are new samples (S401). That is, the new preparation unit 115 prepares a large number of malware samples in the second period of time from the new malware memory apparatus 302, the Internet, or the like. The new preparation unit 115 selects new malware programs for learning from the prepared new malware programs based on a predetermined standard or the like.

Next, the learning apparatus 100 classifies the new malware programs into an existing cluster (S402 to S403). Specifically, the learning apparatus 100 calculates the similarities of the new malware programs (S402) and clusters the new malware programs (S403). That is, the new classification unit 116 calculates the similarity of the new malware program and the existing malware program as samples to each classified cluster, and classifies the new malware program into the cluster with the highest similarity. In a manner similar to the clustering of the existing malware programs described above, the new classification unit 116 calculates the similarities based on classification elements such as the number of occurrences of a predetermined string pattern. For example, the similarity between the number of occurrences of a predetermined string pattern in the new malware program and the average value of the number of occurrences of the predetermined string pattern in the existing malware of each cluster is calculated.

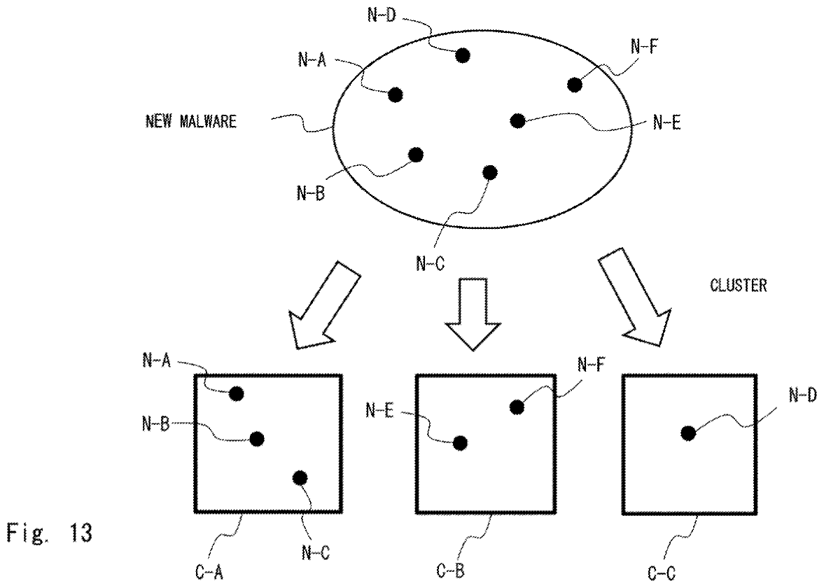

FIG. 13 shows an image of the clustering in S403. In the example of FIG. 13, the new malware includes malware programs N-A to N-F. For example, the malware programs N-A, N-B, and N-C are classified into a cluster C-A, because they have the highest similarities to the cluster C-A (e.g., the numbers of occurrences of a predetermined string pattern of the malware programs are closest to the number of occurrences of the predetermined string pattern of the cluster). The malware programs N-E and N-F are classified into a cluster C-B, because they have the highest similarity to the cluster C-B. The malware program N-D is classified into a cluster C-C, because it has the highest similarity to the cluster C-C.

Next, the learning apparatus 100 calculates a classification rate of the new malware program (S404) and adjusts the feature amount of the cluster (S405). That is, the feature amount adjustment unit 117 calculates the rate (or the number of classified new malware programs) at which the new malware programs are classified into each cluster, and adjusts the feature amount of the cluster used for learning based on the calculated classification rate.

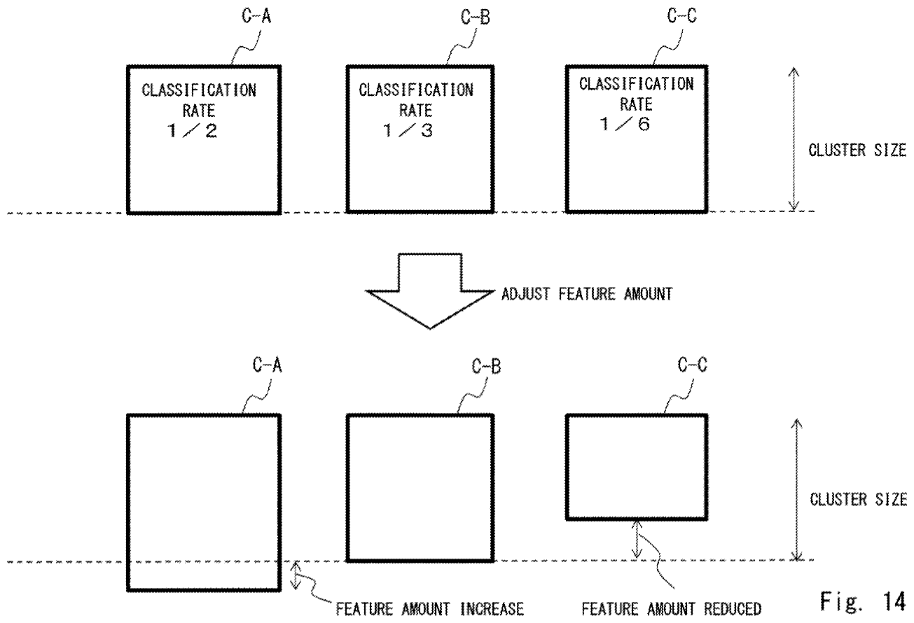

FIG. 14 shows an adjustment image of the feature amount in S405. For example, as shown in FIG. 13, as a result of classifying the new malware programs, three new malware programs are classified into the cluster C-A, two new malware programs are classified into the cluster C-B, and one new malware programs is classified into the cluster C-C. Thus, the classification rate of the cluster C-A is 1/2, that of the cluster C-B is 1/3, and that of the cluster C-C is 1/6. The feature amount of each cluster is adjusted according to the classification rate. Since the classification rate of the cluster C-A is larger than those of the clusters C-B and C-C, the feature amount of the cluster C-A used for learning is increased. Since the classification rate of the cluster C-C is smaller than those of the clusters C-A and C-B, the feature amount of the cluster C-C used for learning is reduced. In a manner similar to the above cluster leveling, when the feature amount of the cluster is increased, the feature amount is added by a predetermined sampling algorithm, and when the feature amount of the cluster is reduced, a part of the feature amount of the cluster is not used (deleted from the cluster). In this case, when the feature amount of the cluster having a reduced feature amount (the malware used as the feature amount is reduced) in the leveling is increased, not only the feature amount is added by the sampling algorithm but also the feature amount of the malware program which is reduced in the leveling may be used.

Following the existing malware processing in S201 and the new malware processing in S202, as shown in FIG. 6, the learning apparatus 100 creates a learning model (S203). That is, the learning unit 118 creates a malware learning model using the adjusted feature amount of each cluster.

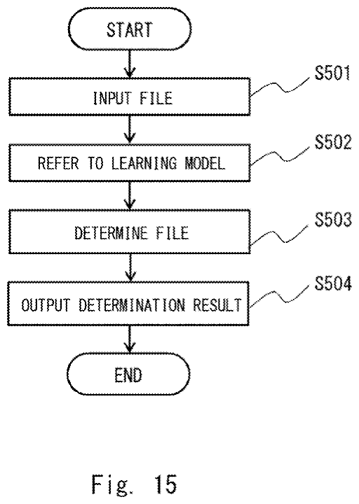

FIG. 15 shows a determination method implemented by the determination apparatus 200 according to this example embodiment. This determination method is executed after the learning model is created by the learning method shown in FIG. 6. In this determination method, a learning model may be created by the learning method shown in FIG. 6.

As shown in FIG. 15, the determination apparatus 200 receives an input of a file from the user (S501). For example, the input unit 210 provides a web interface to the user and acquires the file uploaded by the user on the web interface.

Next, the determination apparatus 200 refers to the learning model (S502) and determines the file based on the learning model (S503). The determination unit 220 refers to the determination learning model created by the learning apparatus 100 and then determines whether or not the input file is malware. A file having the features of the malware learned by the learning model is determined to be “malware”, while a file not having such features is determined to be a “normal file” that is not malware. For example, the feature amount of the input file is extracted, and when the extracted feature amount is close to the feature amount of malware in the learning model than a predetermined range, the input file is determined to be malware.

Next, the determination apparatus 200 outputs the result of determining whether a file is malware or a normal file (S504). For example, the output unit 230 displays the result of determining whether a file is malware or a normal file to the user via the web interface, as in S501. For example, “File is malware” or “File is a normal file” is displayed. In addition, a possibility (probability) that the file may be determined to be malware or a normal file from the distance between the feature amount of the file and the feature amount of the learning model may be displayed.

As described above, in this example embodiment, in the existing malware processing in the first step, the samples are clustered according to the similarity before learning the malware, and in the new malware processing in the second step, the features of the existing malware “similar” to the new malware are applied to the cluster. This makes it possible to learn the feature corresponding to the new malware, thereby improving the determination accuracy of malware of new trends. Further, in this example embodiment, since it is not necessary to extract the feature amount of the new malware, the time required for extracting the feature amount can be reduced, and the feature of new trends in malware can be easily learned. Furthermore, in the clustering of the existing malware, by leveling the classified clusters, it is possible to reduce a variation in the feature amounts of the existing malware to be learned. By clustering new malware in leveled clusters and adjusting the feature amounts of the clusters, it is possible to reliably support new trends in malware.

Note that the present disclosure is not limited to the example embodiment described above, and may be changed as necessary without departing from the scope thereof. For example, the system may be used not only to determine a file provided by a user but also to determine an automatically collected file. Furthermore, the system may be used not only for determining whether a file is malware or a normal file but also for determining whether a file is other abnormal files or normal files.

Each configuration in the above example embodiment may composed of hardware or software, or both of them, or may be composed of one piece of hardware or software, or may be composed of a plurality of pieces of hardware or software. The function (processing) of each apparatus may be implemented by a computer including a CPU, a memory or the like. For example, a program for performing the method (the learning method or determination method) in the example embodiment may be stored in the memory apparatus, and each function may be implemented by executing the program stored in the memory apparatus by the CPU.

These programs can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Although the present disclosure has been described with reference to the above example embodiment, the present disclosure is not limited to the above example embodiment. Various changes can be made to the configurations and details of this disclosure that can be understood by those skilled in the art within the scope of this disclosure.

The whole or part of the exemplary embodiment disclosed above can be described as, but not limited to, the following supplementary notes.
(Supplementary Note 1)

A learning apparatus comprising:

first classification means for classifying a plurality of first malware programs collected in a first period of time into a plurality of clusters;

second classification means for classifying a plurality of second malware programs collected in a second period of time into the plurality of clusters; and

learning means for creating a learning model for determining whether a file is malware based on feature amounts of the plurality of clusters according to a result of the classification of the plurality of second malware programs.
(Supplementary Note 2)

The learning apparatus according to Supplementary note 1, wherein

the first classification means classifies the plurality of first malware programs into the plurality of clusters based on respective similarities of the plurality of first malware programs.
(Supplementary Note 3)

The learning apparatus according to Supplementary note 1 or 2, wherein

the second classification means classifies the plurality of second malware programs into the plurality of clusters based on similarities between the plurality of second malware programs and the plurality of clusters.
(Supplementary Note 4)

The learning apparatus according to Supplementary note 2 or 3, wherein each of the similarities is a similarity of the number of occurrences of a predetermined string pattern.
(Supplementary Note 5)

The learning apparatus according to any one of Supplementary notes 1 to 4, further comprising:

adjustment means for adjusting the feature amounts of the plurality of clusters according to the result of the classification of the plurality of second malware programs, wherein

the learning means creates the learning model based on the adjusted feature amounts.
(Supplementary Note 6)

The learning apparatus according to Supplementary note 5, wherein

the adjustment means adjusts the feature amounts according to the number of the plurality of second malware programs classified into each of the plurality of clusters.
(Supplementary Note 7)

The learning apparatus according to Supplementary note 5, wherein

the adjustment means adjusts the feature amounts according to a classification rate of the plurality of second malware programs in each of the plurality of clusters.
(Supplementary Note 8)

The learning apparatus according to any one of Supplementary notes 1 to 7, further comprising:

leveling means for leveling the plurality of clusters into which the plurality of first malware programs are classified, wherein

the second classification means classifies the plurality of second malware programs into the plurality of leveled clusters.
(Supplementary Note 9)

The learning apparatus according to Supplementary note 8, wherein the leveling means levels the plurality of clusters according to the number of the plurality of first malware programs in each of the plurality of clusters.
(Supplementary Note 10)

The learning apparatus according to Supplementary note 8, wherein the leveling means levels the plurality of clusters according to the feature amounts of the plurality of first malware programs in each of the plurality of clusters.
(Supplementary Note 11)

A determination system comprising:

first classification means for classifying a plurality of first malware programs collected in a first period of time into a plurality of clusters;

second classification means for classifying a plurality of second malware programs collected in a second period of time into the plurality of clusters;

learning means for creating a learning model for determining whether an input file is malware based on feature amounts of the plurality of clusters according to a result of the classification of the plurality of second malware programs; and

determination means for determining whether or not the input file is the malware based on the created learning model.
(Supplementary Note 12)

The determination system according to Supplementary note 11, wherein

the determination means makes the determination based on the feature amount of the file and the feature amount in the learning model.
(Supplementary Note 13)

A learning method comprising:

classifying a plurality of first malware programs collected in a first period of time into a plurality of clusters;

classifying a plurality of second malware programs collected in a second period of time into the plurality of clusters; and

creating a learning model for determining whether a file is malware based on feature amounts of the plurality of clusters according to a result of the classification of the plurality of second malware programs.
(Supplementary Note 14)

The learning method according to Supplementary note 13, wherein

in the classification of the plurality of first malware programs, the plurality of first malware programs are classified into the plurality of clusters based on respective similarities of the plurality of first malware programs.
(Supplementary Note 15)

A learning program for causing a computer to execute:

classifying a plurality of first malware programs collected in a first period of time into a plurality of clusters;

classifying a plurality of second malware programs collected in a second period of time into the plurality of clusters; and

creating a learning model for determining whether a file is malware based on feature amounts of the plurality of clusters according to a result of the classification of the plurality of second malware programs.
(Supplementary Note 16)

The learning program according to Supplementary note 15, wherein

in the classification of the plurality of first malware programs, the plurality of first malware programs are classified into the plurality of clusters based on respective similarities of the plurality of first malware programs.

### REFERENCE SIGNS LIST

1, 2 DETERMINATION SYSTEM
10 LEARNING APPARATUS
11 FIRST CLASSIFICATION UNIT
12 SECOND CLASSIFICATION UNIT
13 LEARNING UNIT
20 DETERMINATION APPARATUS
21 DETERMINATION UNIT
100 LEARNING APPARATUS
110 CONTROL UNIT
111 EXISTING PREPARATION UNIT
111a PREPARATION UNIT
112 FEATURE AMOUNT EXTRACTION UNIT
113 EXISTING CLASSIFICATION UNIT
113a CLASSIFICATION UNIT
114 LEVELING UNIT
115 NEW PREPARATION UNIT
116 NEW CLASSIFICATION UNIT
117 FEATURE AMOUNT ADJUSTMENT UNIT
118 LEARNING UNIT
120 MEMORY UNIT
121 FEATURE AMOUNT MEMORY UNIT
122 CLUSTER MEMORY UNIT
200 DETERMINATION APPARATUS
210 INPUT UNIT
220 DETERMINATION UNIT
230 OUTPUT UNIT
300 MALWARE MEMORY APPARATUS
301 EXISTING MALWARE MEMORY APPARATUS
302 NEW MALWARE MEMORY APPARATUS
400 LEARNING MODEL MEMORY APPARATUS

What is claimed is:

1. A learning apparatus comprising:
a memory storing instructions, and
a processor configured to execute the instructions stored in the memory to;
classify a plurality of first malware programs collected in a first period of time into a plurality of clusters;
classify a plurality of second malware programs collected in a second period of time into the plurality of clusters; and
create a learning model for determining whether a file is malware based on feature amounts of the plurality of clusters according to a result of the classification of the plurality of second malware programs.

2. The learning apparatus according to claim 1, wherein the processor is further configured to execute the instructions stored in the memory to classify the plurality of first malware programs into the plurality of clusters based on respective similarities of the plurality of first malware programs.

3. The learning apparatus according to claim 1 wherein the processor is further configured to execute the instructions stored in the memory to classify the plurality of second malware programs into the plurality of clusters based on similarities between the plurality of second malware programs and the plurality of clusters.

4. The learning apparatus according to claim 2, wherein each of the similarities is a similarity of the number of occurrences of a predetermined string pattern.

5. The learning apparatus according to claim 1, wherein
the processor is further configured to execute the instructions stored in the memory to adjust the feature amounts of the plurality of clusters according to the result of the classification of the plurality of second malware programs, and
create the learning model based on the adjusted feature amounts.

6. The learning apparatus according to claim 5, wherein
the processor is further configured to execute the instructions stored in the memory to adjust the feature amounts according to the number of the plurality of second malware programs classified into each of the plurality of clusters.

7. The learning apparatus according to claim 5, wherein
the processor is further configured to execute the instructions stored in the memory to adjust the feature amounts according to a classification rate of the plurality of second malware programs in each of the plurality of clusters.

8. The learning apparatus according to claim 1, wherein
the processor is further configured to execute the instructions stored in the memory to level the plurality of clusters into which the plurality of first malware programs are classified, and
classify the plurality of second malware programs into the plurality of leveled clusters.

9. The learning apparatus according to claim 8, wherein
the processor is further configured to execute the instructions stored in the memory to level the plurality of clusters according to the number of the plurality of first malware programs in each of the plurality of clusters.

10. The learning apparatus according to claim 8, wherein
the processor is further configured to execute the instructions stored in the memory to level the plurality of clusters according to the feature amounts of the plurality of first malware programs in each of the plurality of clusters.

11. A determination system comprising:
a memory storing instructions, and
a processor configured to execute the instructions stored in the memory to;
classify a plurality of first malware programs collected in a first period of time into a plurality of clusters;
classify a plurality of second malware programs collected in a second period of time into the plurality of clusters;
create a learning model for determining whether an input file is malware based on feature amounts of the plurality of clusters according to a result of the classification of the plurality of second malware programs; and
determine whether or not the input file is the malware based on the created learning model.

12. The determination system according to claim 11, wherein
the processor is further configured to execute the instructions stored in the memory to make the determination based on the feature amount of the file and the feature amount in the learning model.

13. A learning method comprising:
classifying a plurality of first malware programs collected in a first period of time into a plurality of clusters;
classifying a plurality of second malware programs collected in a second period of time into the plurality of clusters; and
creating a learning model for determining whether a file is malware based on feature amounts of the plurality of clusters according to a result of the classification of the plurality of second malware programs.

14. The learning method according to claim 13, wherein
in the classification of the plurality of first malware programs, the plurality of first malware programs are classified into the plurality of clusters based on respective similarities of the plurality of first malware programs.

15. A non-transitory computer readable medium storing a learning program for causing a computer to execute:
classifying a plurality of first malware programs collected in a first period of time into a plurality of clusters;
classifying a plurality of second malware programs collected in a second period of time into the plurality of clusters; and
creating a learning model for determining whether a file is malware based on feature amounts of the plurality of clusters according to a result of the classification of the plurality of second malware programs.

16. The non-transitory computer readable medium according to claim 15, wherein
in the classification of the plurality of first malware programs, the plurality of first malware programs are classified into the plurality of clusters based on respective similarities of the plurality of first malware programs.
